(19) United States
(12) Patent Application Publication
(10) Pub. No.: US 2017/0167717 A1
(43) Pub. Date: Jun. 15, 2017

(54) DIFFRACTIVE AND PRISMATIC OLED WIRELESS AND LED WIRELESS UNDERWATER POOL LIGHT SOURCES

(71) Applicant: E Z Wireles LED Light Company, Hilton, NY (US)

(72) Inventor: Francisco J. Duarte, Rochester, NY (US)

(21) Appl. No.: 14/967,337

(22) Filed: Dec. 13, 2015

(51) Int. Cl. F21V 31/00; F21K 99/00; F21S 9/02; F21V 5/04; G02B 5/18; F21S 8/00; H05B 37/02; F21V 5/02

(52) U.S. Cl. CPC F21V 31/005; H05B 37/0272; F21K 9/50; F21V 5/02; F21V 5/04; G02B 5/18; F21S 8/033; F21S 9/02; G02B 2005/1804; F21Y 2101/02; F21Y 2103/003

(57) ABSTRACT

The systems and methods described herein relate to wireless solid-state semiconductor illumination devices, such as organic light emitting diodes (OLEDs), and/or light emitting diodes (LEDs), configured in arrays capable of generating light via a diffractive transmission layer and prismatic surfaces for illumination purposes. The OLEDs, or LEDs, can be deployed in arrays yielding a variety of geometrical configurations such as linear arrays, square arrays, pentagonal arrays, hexagonal arrays, octagonal arrays, other polygonal arrays, and arrays approaching a circular configuration. One of the features of these solid-state semiconductor (OLED and LED) illumination arrays is that they are driven by immediately adjacent battery power sources, they are wireless, and can controlled remotely.

### FIELD OF THE INVENTION

The invention relates to wireless underwater pool illumination devices using arrays of solid-state semiconductor illuminating devices, such as organic light emitting diodes (OLEDs), and/or light emitting diodes (LEDs). More specifically, the invention relates to wireless underwater pool light configurations using OLEDs, and/or LEDs, illumination sources in various geometrical configurations in addition to diffractive and prismatic elements utilized to spatially pattern the emitted light and disperse the spectrum of the emitted light.

### BACKGROUND OF THE INVENTION

Underwater pool lights use wall-plug alternate voltage (such as 110 V, as available in the U. S.) to excite, via cable transmission lines, either incandescent or halogen light bulbs. The light bulbs are usually housed in hermitically sealed metal-glass cavities as described in U.S. Pat. No. 5,051,875. In these pool lights, as times goes by, water and pool chemicals can corrode the metals and allow humidity, or even water, near the light bulb thus causing damage to the electrical connections and light bulb, either of which culminates in light failure. More recently, LED versions of cable-fed light configurations have become available, as described in U.S. Pat. No. 6,184,628. Commercial versions of these LED powered pool lights also include metal parts that with prolonged exposure to pool chemicals can also be subject to corrosion. Replacing the light-bulbs, either incandescent, halogen, or LEDs, requires removal of the underwater light housing, unwinding the cable behind the light housing, replacement of the corroded parts, and/or light bulb, and re mounting of the light fixture to the anchor attached to the wall of the pool. This exercise can require the service of skilled technicians and is not free of risk and danger due to accidental events.

It is therefore necessary to introduce easy-to-mount wireless, and/or cable-less, battery driven solid-state underwater lighting fixtures manufactured with insulating corrosion-resistant materials, such as polymer, or plastics, for the housing. An appropriate battery generated voltage range (3-15 V, for example) can directly drive commercially available OLED or LED light sources which can be remotely turned ON or OFF by the pool operator.

For ease of fabrication the OLED or LED lights can be arranged in a variety of geometrical configurations starting from linear arrays, square arrays, rectangular arrays, pentagonal arrays, hexagonal arrays, octagonal arrays, other polygonal arrays, all the ways to arrays approximating a circular geometry. The use of single large emitting area OLEDs is also part of this invention.

For linear, square, rectangular, pentagonal, hexagonal, and octagonal arrays, the clear polymer, or plastic, surface transmitting the light to the pool water can be prismatic in character thus providing dispersion or decomposition of the original white light into its various spectral components. In other words, multi colored light emission. In addition a diffractive grating array is deployed post light and prior to the polymer surface to create diffractive light patterns.

### SUMMARY OF THE INVENTION

An object of the present invention is to provide wireless, remotely controlled, battery driven solid-state semiconductor underwater light sources configured in arrays of OLEDs, and/or LEDs, in various geometries starting from linear arrays, to square arrays, rectangular arrays, pentagonal arrays, hexagonal arrays, octagonal arrays, and polygonal arrays in general, all the ways to arrays approximating circular arrays.

Another object of the present invention is to provide wireless, remotely controlled, battery driven solid-state semiconductor, OLED, and/or LED, underwater light sources integrating OLEDs, and/or LEDs, arrays in various geometrical configurations which illuminate a diffractive transmission grating prior to output coupling the light via the output lens or output optical window. This feature also allows for the projection of specific images and characters.

An additional object of the present invention is to provide a wireless, remotely controlled, battery driven, OLED, and/or LED, underwater light sources integrating OLEDs, and/or LEDs, arrays in various geometrical configurations which illuminate a diffractive two-dimensional transmission grating prior to output coupling the light via a geometrical array of refractive prisms configuring the output optical window of the light source. The function of the prisms is to induce refraction of the white light OLEDs, and/or LEDs, thus providing a spectral decomposition into the various color components of the white light emission.

According to one aspect of the invention, there are provided a wireless, remotely controlled, battery driven, OLED, and/or LED, underwater light sources integrating arrays of OLEDs, and/or LEDs, in various geometrical configurations which illuminate a diffractive two-dimensional transmission grating prior to output coupling the light via a lens or via a geometrical array of refractive prisms configuring the output window of the light source. The hermetically sealed housing for the batteries, OLEDs, and/or LEDs, and necessary electronics components is made of plastic materials. Lenses and/or refractive prisms comprising the output window are made of transparent optical grade plastics, such as optical grade acrylic plastic, other suitable polymers, or glass.

In addition to the hermetically sealed housing applied in this invention, further protection from humidity can be provided by using OLEDs packaged using hermetically sealing techniques as described, for example, in US Patent Application 20080048556 A1.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a top view of a linear array of N circular LEDs with a planar optical window.

FIG. 2 depicts a linear array of N circular LEDs with a prismatic optical window.

FIG. 3 shows the top view of a single large area rectangular OLED with a planar optical window.

FIG. 4 depicts a single large area rectangular OLED with a prismatic optical window.

FIG. 5 shows a top view of a rectangular array of N circular LEDs with a planar optical window.

FIG. 6 depicts a rectangular array of N circular LEDs with a prismatic optical window.

FIG. 7 shows a top view of a rectangular array of N large emitting area rectangular OLEDs with a planar optical window.

FIG. 8 depicts a large square emitting area OLED with a planar optical window.

FIG. 9 shows a top view of a pentagonal array of N LEDs with a multiple prism optical window.

FIG. 10 depicts a hexagonal array of N LEDs with a multiple prism optical window.

FIG. 11 depicts an octagonal array of N LEDs with a multiple prism optical window.

FIG. 12 shows a top view of a circular array of N LEDs with a planar or curved window configuring a lens.

FIG. 13 depicts a near circular array of N OLEDs with a planar or curved circular window configuring a lens.

FIG. 14 depicts an array of rectangular large emitting area N OLEDs with a planar or curved circular window configuring a lens.

FIG. 15 shows a top view of an oval array of N LEDs with a planar or curved oval window configuring a lens.

FIG. 16 shows a side perspective of a complete remotely controlled light system comprising top section, which includes output lens, and lower section which includes space for diffractive layer, OLED array, or LED array, batteries, and electronics. The top and lower sections are secured by a series of screws and joined by a circular O ring. The lower section includes a central threaded cylinder and gasket for secured attachment to the pool's wall.

FIG. 17 shows a side and top perspectives of a complete remotely controlled light system comprising top section, which includes a flat (or planar) output optical window within an overall rectangular configuration, and lower section which includes space for diffractive layer, rectangular OLED, batteries, and electronics. The top and lower sections are secured by a series of screws and joined by a rectangular rubber, or neoprene, gasket. The lower section includes a central threaded cylinder and rubber, or neoprene, gasket for secure attachment to the pool's wall.

FIG. 18 shows a horizontal side and top perspectives of a complete remotely controlled light system comprising upper section, which includes a flat output optical window within an overall square configuration, and lower section which includes space for diffractive layer, LED array, batteries, and electronics. The top and lower sections are secured by a series of screws and joined by a square rubber, or neoprene, gasket. The lower section includes a central threaded cylinder and rubber, or neoprene, gasket for secured attachment to the pool's wall.

FIG. 19 shows a horizontal side, top, and vertical side perspectives of a complete remotely controlled light system comprising upper section, which includes a prismatic output window within an overall square configuration, and lower section which includes space for diffractive layer, LED array, batteries, and electronics. The top and lower sections are secured by a series of screws and joined by a square rubber, or neoprene, gasket. The lower section includes a central threaded cylinder and rubber, or neoprene, gasket for secured attachment to the pool's wall. FIG. 19 also depicts the vertical side view which shows a single prism optical window.

FIG. 20 shows a side and top perspective of a complete remotely controlled light system comprising a circular upper section, which includes a prismatic output window within an overall pyramidal configuration, and circular lower section which includes space for diffractive layer, LED array, batteries, and electronics. The upper and lower sections are secured by a series of screws and joined by a circular O ring. The lower section includes a central threaded cylinder and rubber, or neoprene, gasket for secured attachment to the pool's wall. FIG. 20 depicts the side and top views of the square array of N circular LEDs with a plurality of prisms comprising the pyramidal output optical window.

FIG. 21 shows a side and top perspective of a complete remotely controlled light system comprising a square upper section, which includes a prismatic output window within an overall pyramidal configuration, and square lower section which includes space for diffractive layer, LED array, batteries, and electronics. The upper and lower sections are secured by a series of screws and joined by a square gasket. The lower section includes a central threaded cylinder and rubber, or neoprene, gasket for secured attachment to the pool's wall. FIG. 21 depicts the side and top views of a large square emitting area OLED with a plurality of prisms comprising the pyramidal output optical window.

FIG. 22 shows a side and top perspective of a complete remotely controlled light system comprising an upper section, which includes a prismatic output window within an overall pentagonal configuration, and lower section which includes space for diffractive layer, LED array, batteries, and electronics. The top and lower sections are secured by a series of screws and joined by a circular O ring. The lower section includes a central threaded cylinder and rubber, or neoprene, gasket for secured attachment to the pool's wall. FIG. 22 depicts the side and top views of the pentagonal array of N circular LEDs with a plurality of prisms comprising the pentagonal output optical window.

FIG. 23 shows a side and top perspective of a complete remotely controlled light system comprising an upper section, which includes a prismatic output window within an overall hexagonal configuration, and lower section which includes space for diffractive layer, LED array, batteries, and electronics. The upper and lower sections are secured by a series of screws and joined by a circular O ring. The lower section includes a central threaded cylinder and rubber, or neoprene, gasket for secured attachment to the pool's wall. FIG. 23 depicts the side and top views of the hexagonal array of N circular LEDs with a plurality of prisms comprising the hexagonal output optical window.

FIG. 24 shows a side and top perspective of a complete remotely controlled light system comprising an upper section, which includes a prismatic output window within an overall octagonal configuration, and lower section which includes space for diffractive layer, LED array, batteries, and electronics. The upper and lower sections are secured by a series of screws and joined by a circular O ring. The lower section includes a central threaded cylinder and rubber, or neoprene, gasket for secured attachment to the pool's wall. FIG. 24 depicts the side and top views of the octagonal array of N circular LEDs with a plurality of prisms comprising the octagonal output optical window.

FIG. 25 shows a side and top perspective of a complete remotely controlled light system comprising an upper section, which includes a circular-lens output window within an overall circular configuration, and lower section which includes space for diffractive layer, LED array, batteries, and electronics. The upper and lower sections are secured by a series of screws and joined by a circular O ring. The lower section includes a central threaded cylinder and rubber, or neoprene, gasket for secured attachment to the pool's wall. FIG. 25 depicts the side and top views of the circular array of N circular LEDs with a circular-lens output optical window.

FIG. 26 shows a side and top perspective of a complete remotely controlled light system comprising an upper section, which includes a circular-lens output window within an overall circular configuration, and lower section which includes space for diffractive layer, OLED array, batteries, and electronics. The top and lower sections are secured by a series of screws and joined by a circular O ring. The lower section includes a central threaded cylinder and rubber, or neoprene, gasket for secured attachment to the pool's wall. FIG. 26 depicts the side and top views of the circular array of N circular OLEDs with a circular-lens output optical window.

FIG. 27 shows a side and top perspective of a complete remotely controlled light system comprising an upper section, which includes a circular-lens output window within an overall circular configuration, and lower section which includes space for diffractive layer, OLED array, batteries, and electronics. The upper and lower sections are secured by a series of screws and joined by a circular O ring. The lower section includes a central threaded cylinder and rubber, or neoprene, gasket for secured attachment to the pool's wall. FIG. 27 depicts the side and top views of the circular array of N rectangular OLEDs with a circular-lens output optical window.

FIG. 28 shows a circuit configuration of the remotely controlled light system comprising power source, or battery array, remotely controlled switch, and N-element semiconductor illumination array. The N-element semiconductor illumination array is integrated by either N OLEDs or N LEDs.

FIG. 29 shows a circuit of the digital switch controlling module. It also depicts a dual light emitting trigger to be used by the operator.

FIG. 30 illustrates the displacement of the battery series pack and switch circuitry which are deployed under the printer circuit and OLED, or LED, arrays.

FIG. 31 shows a cross section of the diffraction light pattern generated by an OLED-grating system corresponding to the geometry and dimensions depicted previously in FIG. 17.

FIG. 32 illustrates a permissible refraction light-path due to an LED-prism combination similar to that depicted in FIG. 19.

### DETAILED DESCRIPTION OF THE INVENTION

The following is a detailed description of the preferred embodiments of the invention, reference being made to the drawings in which the reference numerals identify the

elements of structure in each of the several figures. The present invention is directed to remotely controlled, battery driven, wireless underwater pool illumination devices using arrays of organic light emitting diodes (OLEDs), and/or arrays of light emitting diodes (LEDs), as light source. As will become apparent, in an embodiment, the emission from the OLED, or LED, array is transmitted via a diffraction inducing optical grating and exits the device through an optical window configured in a lens geometry or a plurality of refractive prisms.

As it will be more particularly described the OLED, and/or LED, arrays are comprised of N illuminating elements, where N is greater than 1 and up to an arbitrary large number of illuminating elements, arranged in any linear, square, rectangular, pentagonal, hexagonal, octagonal, polygonal, circular, or oval configurations.

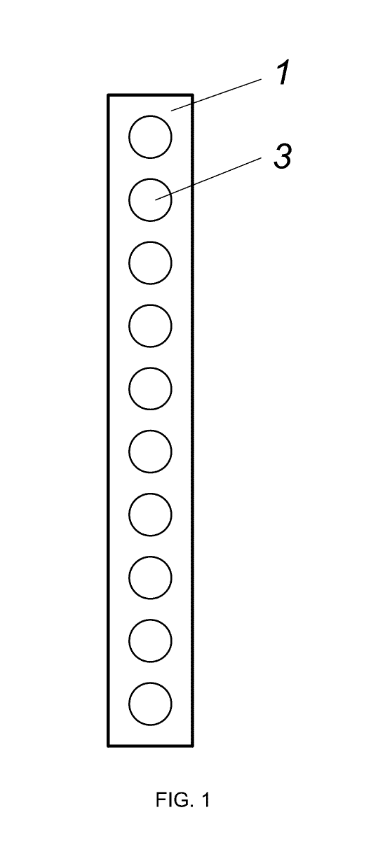

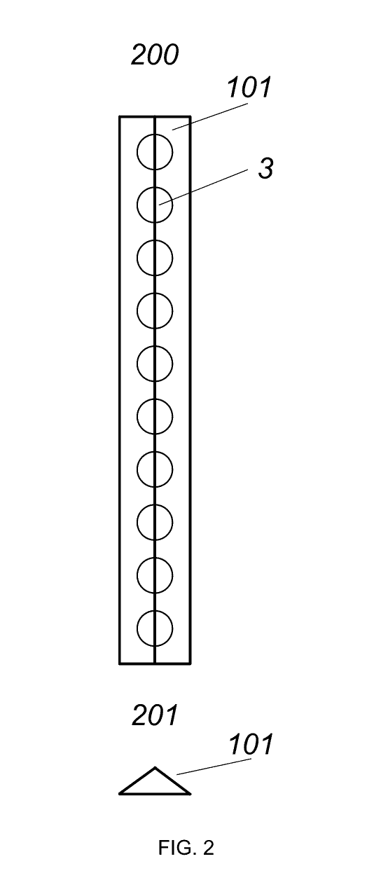

FIG. 1 shows a top view of a linear array of N circular LEDs 3 with a planar or curved optical window 1. FIG. 2 includes diagram 200 which depicts a linear array of N circular LEDs 3 with a prismatic optical window 101. The prismatic profile of the optical window is shown in diagram 201.

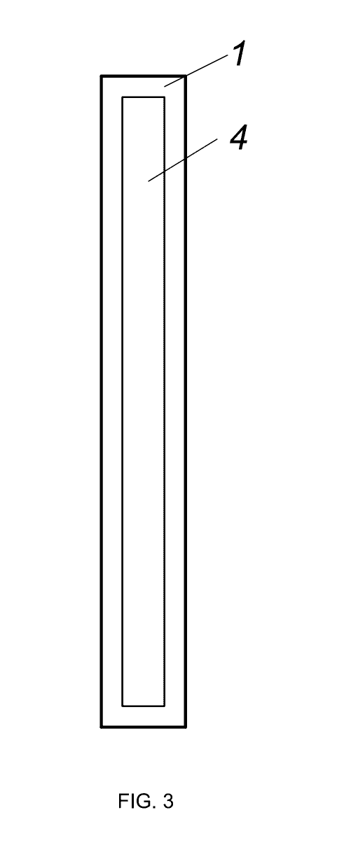

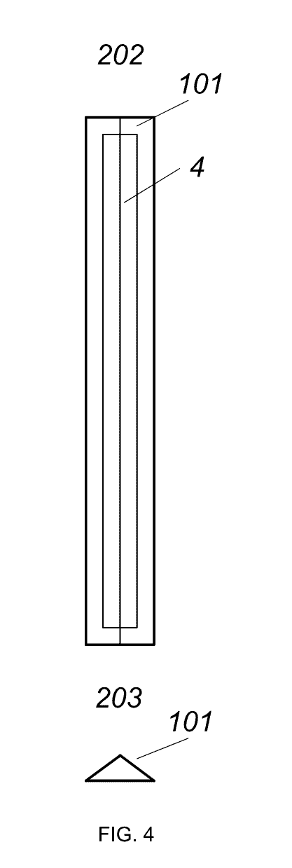

FIG. 3 shows the top view of a single large area OLED 4 with a planar or curved optical window 1. FIG. 4 includes diagram 202 which depicts a single large area OLED 4 with a prismatic optical window 101. The prismatic profile of the optical window is shown in diagram 203.

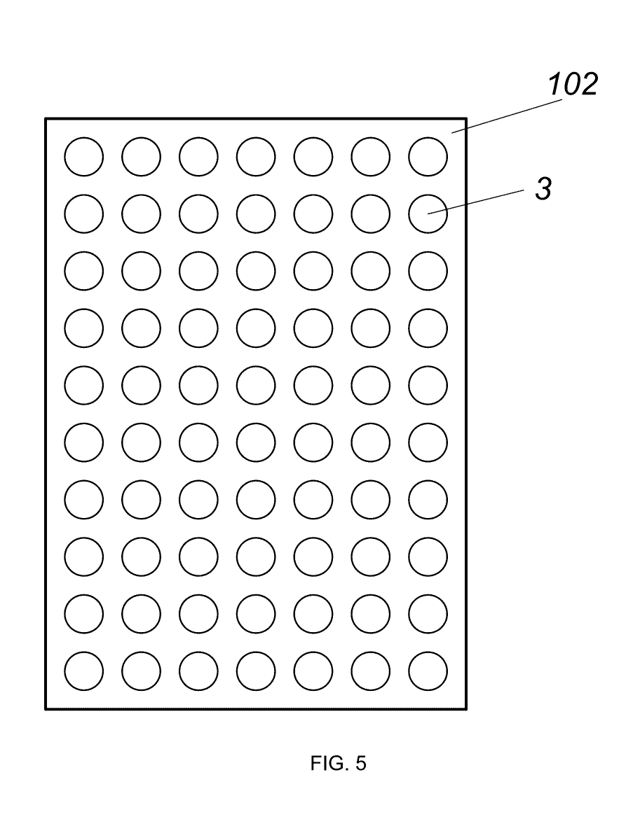

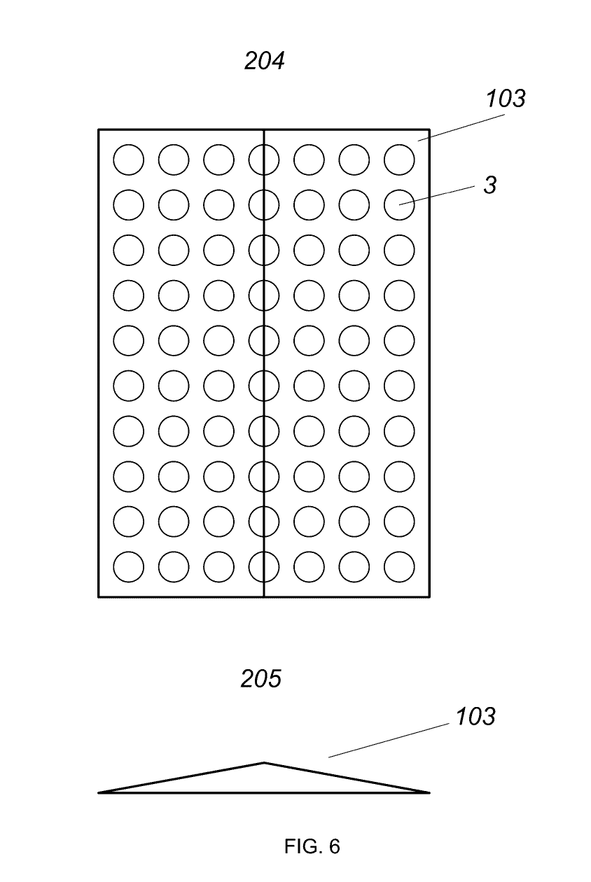

FIG. 5 shows a top view of a rectangular array of N circular LEDs 3 with a planar or curved optical window 102. FIG. 6 includes diagram 204 which depicts a rectangular array of N circular LEDs 3 with a prismatic optical window 103. The prismatic profile of the optical window is shown in diagram 205.

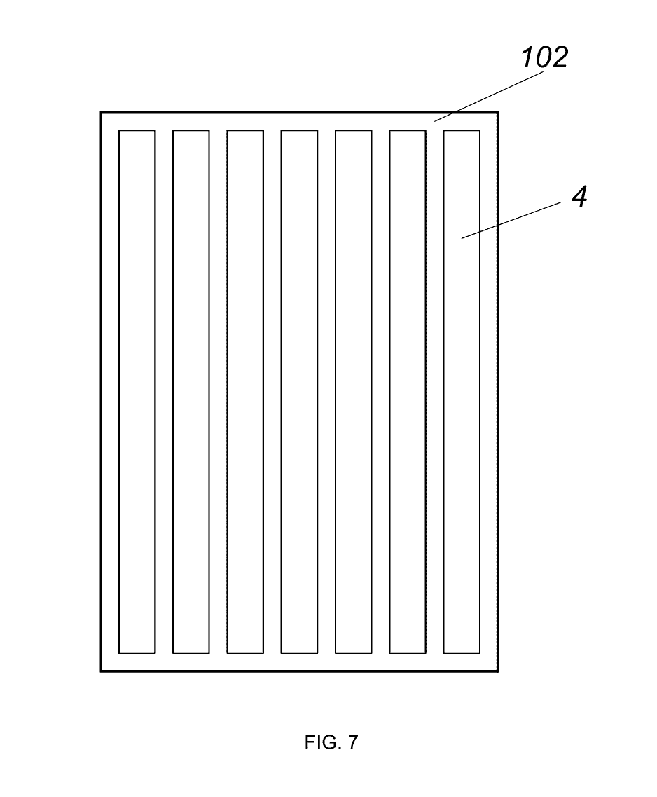

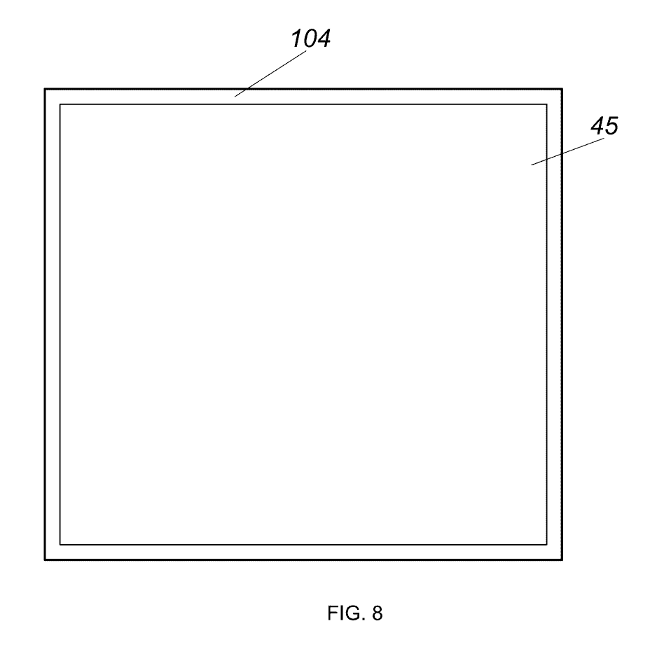

FIG. 7 shows a top view of a rectangular array of N large emitting area rectangular OLEDs 4 with a planar or curved optical window 102. FIG. 8 depicts a large square emitting area OLED 45 with a planar or curved optical window 104.

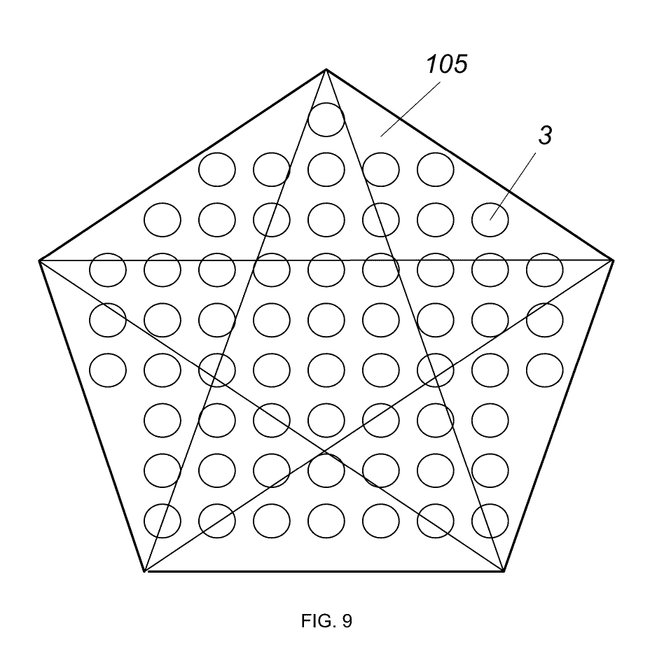

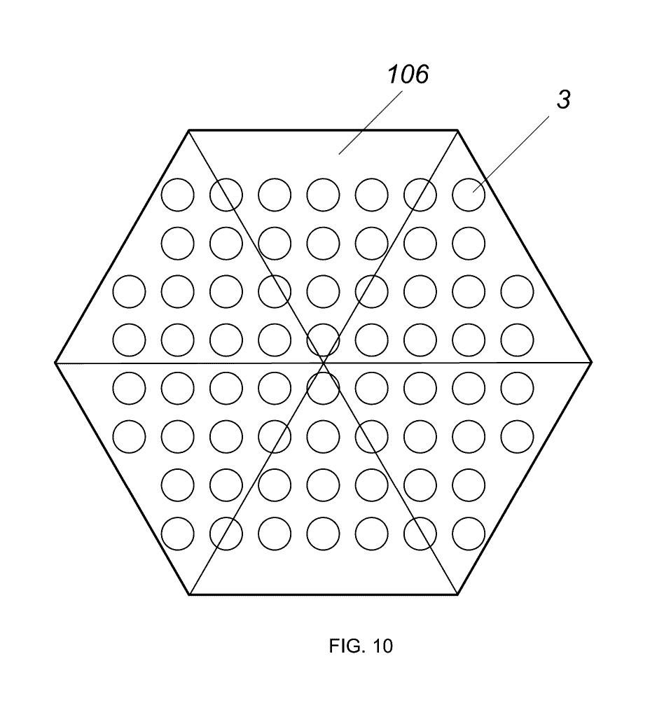

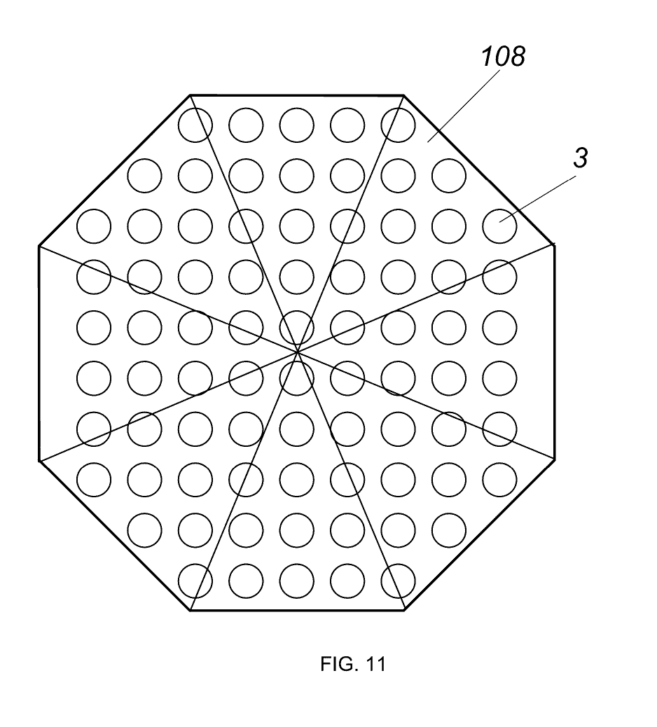

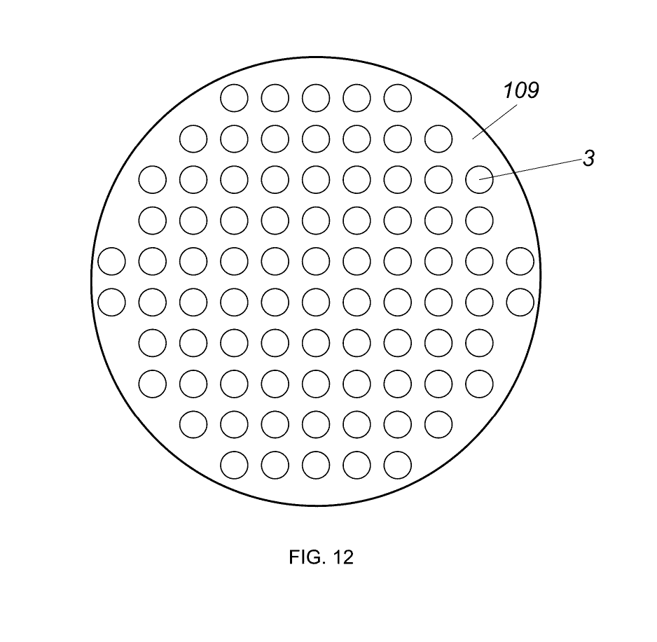

FIG. 9 shows a top view of a pentagonal array of N LEDs 3 with a pentagonal multiple prism optical window 105. FIG. 10 depicts a hexagonal array of N LEDs 3 with a hexagonal multiple prism optical window 106. FIG. 11 depicts an octagonal array of N LEDs 3 with an octagonal multiple prism optical window 108. FIG. 12 shows a top view of a circular array of N LEDs 3 with a planar or curved circular window configuring a lens 109.

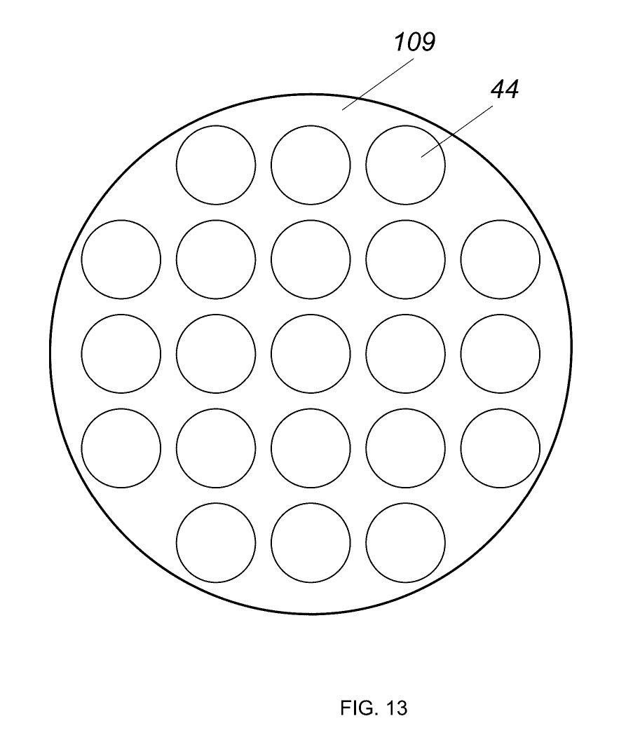

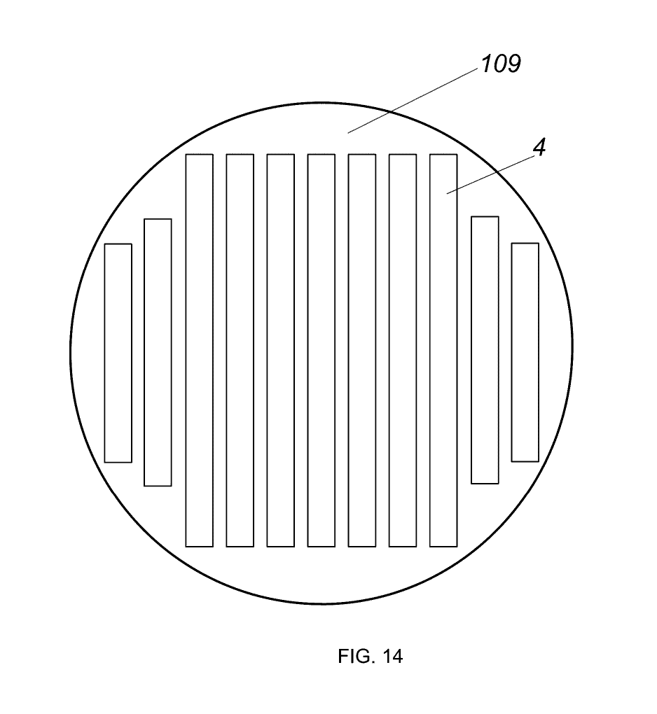

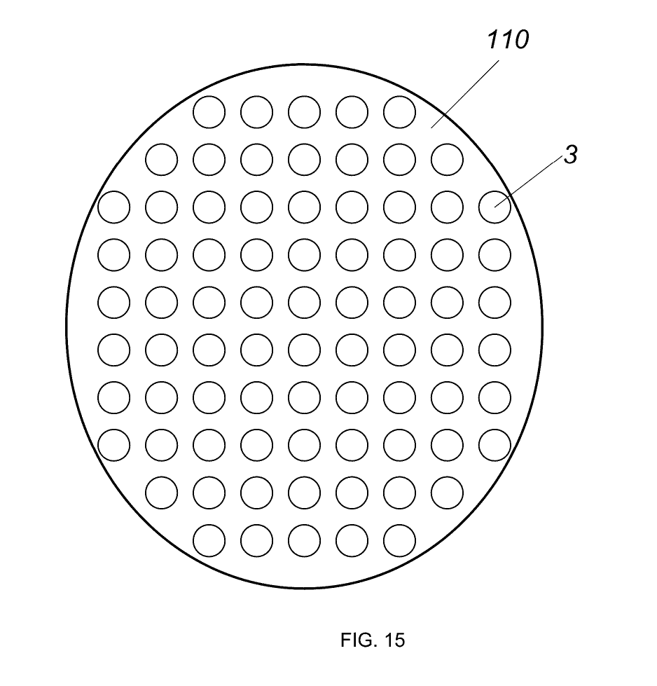

FIG. 13 depicts a circular array of N OLEDs 4 with a planar or curved window configuring a circular lens 109. FIG. 14 depicts an array of rectangular large emitting area N OLEDs 44 with a planar or curved window configuring a circular lens 109. FIG. 15 shows a top view of an oval array of N LEDs 3 with a planar or curved window configuring an oval lens 110.

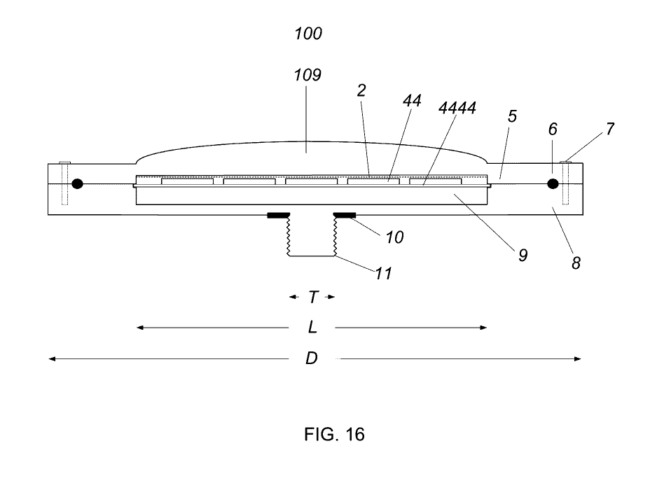

FIG. 16 shows a side perspective of a complete remotely controlled light system 100 comprising upper section 5, which includes the output lens 109. Immediately under the lens the system includes a diffraction grating 2, and N OLED 44 array mounted on a printed circuit 4444. The lower section 8 includes the space 9 for the printed circuit 4444, batteries, and electronics. The upper 5 and lower 8 sections are secured by a series of screws 7 and joined by a circular O ring 6. The lower section includes a central threaded cylinder 11 and rubber, or neoprene, gasket 10 for secured attachment to the pool's wall. A particular example of this embodiment has dimensions of an overall diameter D of about 48.6 cm with a lens diameter of the optical window L of about 32.4 cm. This particular example has a threaded cylinder 11 with a diameter T of about 45 mm which is compatible with 1.75 inch diameter returns common in the swimming pool industry.

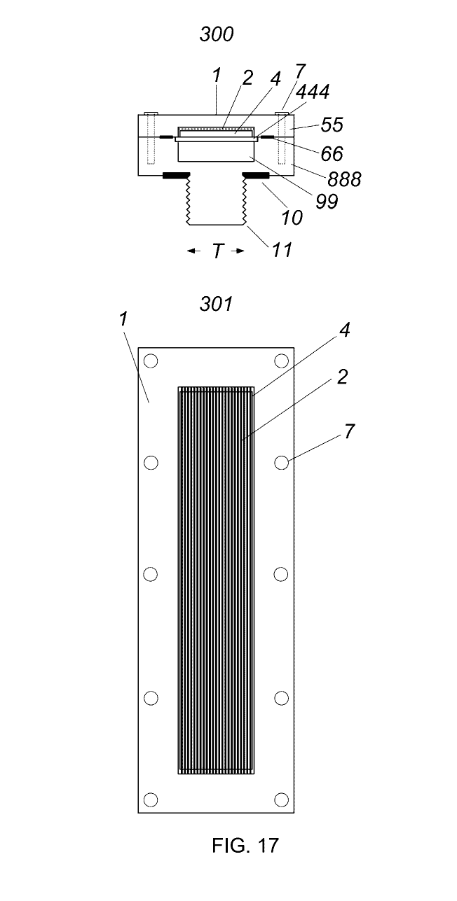

FIG. 17 shows a side perspective of a complete remotely controlled light system 300 comprising upper section 55, which includes a flat output optical window 1 within an overall rectangular configuration. Section 55 includes a space for the transmission diffractive layer 2, and large rectangular OLED 4 which is mounted on a printed circuit 444. The lower section 888 includes space 99 which includes the printed circuit 444, batteries, and electronics. The upper and lower sections are secured by a series of screws 7 and joined by a square rubber, or neoprene, gasket 66. The lower section 888 includes a central threaded cylinder 11 and rubber, or neoprene, gasket 10 for secured attachment to the pool's wall. FIG. 17 also depicts the top, or frontal, perspective 301 that displays the rectangular OLED covered with an N-slit transmission diffraction grating 2 and output planar optical window 1.

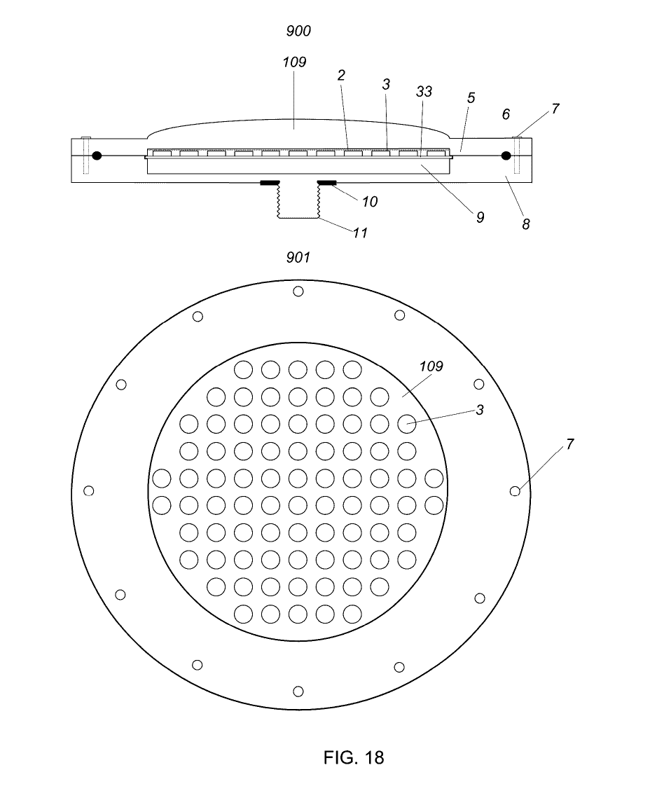

FIG. 18 shows a side perspective of a complete remotely controlled light system 400 comprising upper section 555, which includes a flat output window 111 within an overall square configuration. Section 555 also includes a space for the transmission diffraction layer 2, and LED 3 array which is mounted on a printed circuit 33. The lower section 88 includes space 9 for the printed circuit 33, batteries, and electronics. The upper and lower sections are secured by a series of screws 7 and joined by an O ring 6. The lower section 88 includes a central threaded cylinder 11 and rubber, or neoprene, gasket 10 for secured attachment to the pool's wall. FIG. 18 also depicts the top, or frontal, perspective 403 that displays the square array of N circular LEDs 3, diffraction grating 2, with a prismatic optical window 113.

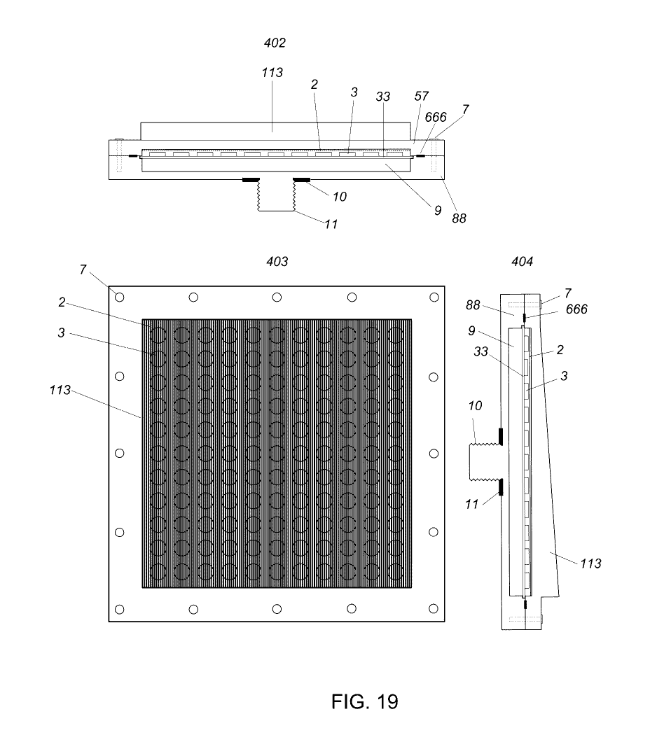

FIG. 19 shows a side horizontal, top, side vertical perspectives of a complete remotely controlled light system 402 comprising upper section 57, which includes a prismatic output window 113 within an overall square configuration. Section 57 also includes a space for the transmission diffraction layer 2, and LED 3 array which is mounted on a printed circuit 33. The lower section 8 includes space 9 for the printed circuit 33, batteries, and electronics. The upper and lower sections are secured by a series of screws 7 and joined by an O ring 6. The lower section 8 includes a central threaded cylinder 11 and rubber, or neoprene, gasket 10 for secured attachment to the pool's wall. FIG. 18 also depicts the top, or frontal, perspective 401 that displays the square array of N circular LEDs 3 with a flat optical window 107. The diffractive layer, or transmission grating 2, is not displayed in this perspective.

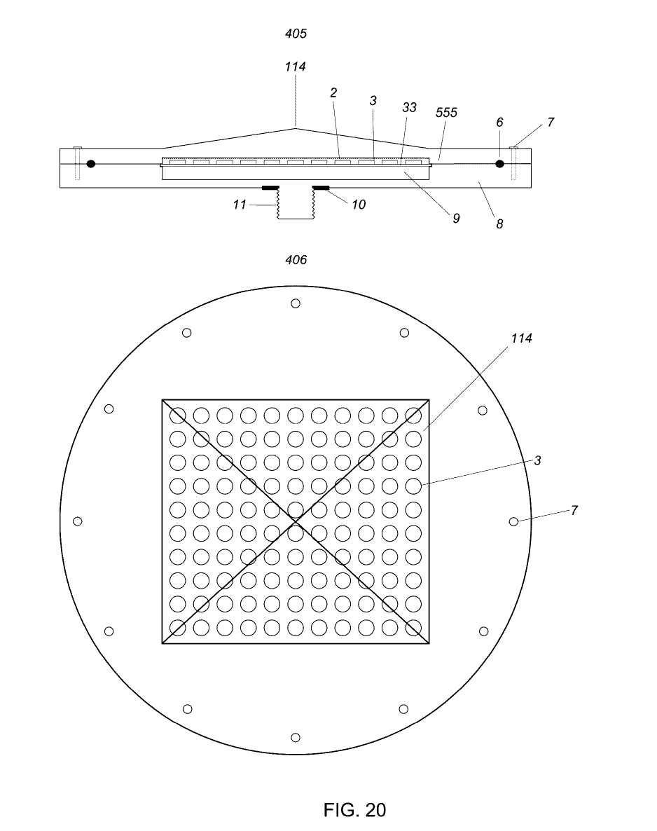

FIG. 20 shows a side perspective of a complete remotely controlled light system 405 comprising upper section 555, which includes a prismatic output window 114 within an overall square configuration. Section 555 also includes a space for the transmission diffraction layer 2, and LED 3 array which is mounted on a printed circuit 33. The lower section 8 includes space 9 for the printed circuit 33, batteries, and electronics. The top and lower sections are secured by a series of screws 7 and joined by a circular O ring 6. The lower section 8 includes a central threaded cylinder 11 and rubber, or neoprene, gasket 10 for secured attachment to the pool's wall. FIG. 20 also depicts the top, or frontal, perspective 406 that displays the square array of N circular LEDs 3 with a four-prism pyramidal arrangement comprising the output optical window 114. The diffractive layer, or transmission grating 2, is not displayed in this perspective.

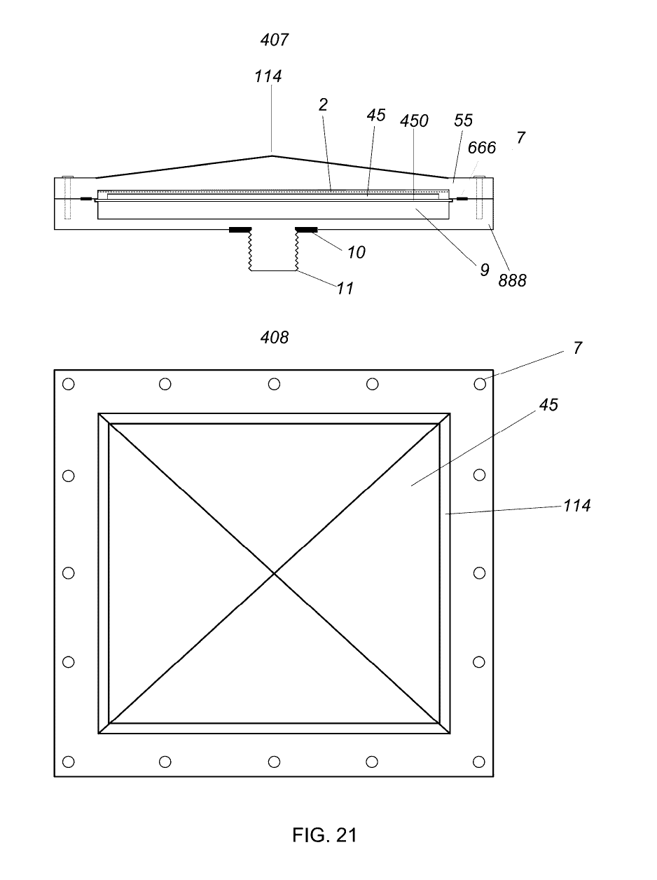

FIG. 21 shows a side perspective of a complete remotely controlled light system 407 comprising upper section 55, which includes a prismatic output window 114 within an overall square configuration. Section 55 also includes a space for the transmission diffraction layer 2, and large square emitting area OLED 45 which is mounted on a printed circuit 450. The lower section 888 includes space 9 for the printed circuit 450, batteries, and electronics. The upper and lower sections are secured by a series of screws 7 and joined by a square rubber, or neoprene, gasket 666. The lower section 888 includes a central threaded cylinder 11 and rubber, or neoprene, gasket 10 for secured attachment to the pool's wall. FIG. 21 also depicts the top, or frontal, perspective 408 that displays the large square emitting area OLED 45 with a four-prism pyramidal arrangement comprising the output optical window 114. The diffractive layer, or transmission grating 2, is not displayed in this perspective.

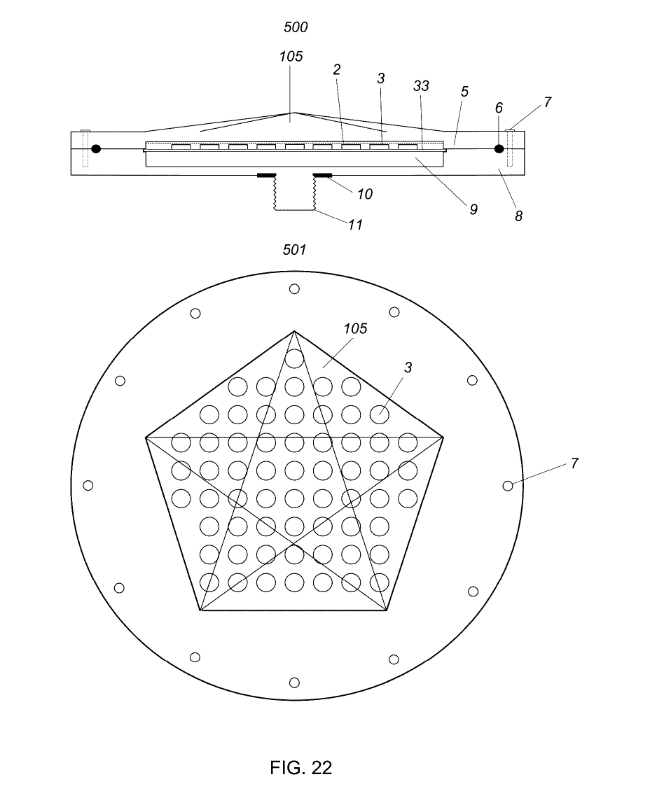

FIG. 22 shows a side perspective of a complete remotely controlled light system 500 comprising top section 5, which includes a prismatic output window 105 within an overall pentagonal configuration. Section 5 also includes a space for the transmission diffraction layer 2, and LED 3 array which is mounted on a printed circuit 33. The lower section 8 includes space 9 for the printed circuit 33, batteries, and electronics. The upper and lower sections are secured by a series of screws 7 and joined by a rubber circular O ring 6. The lower section 8 includes a central threaded cylinder 11 and rubber gasket 10 for secured attachment to the pool's wall. FIG. 22 also depicts the top, or frontal, perspective 501 that displays the pentagonal array of N circular LEDs 3 and the plurality of prisms comprising the pentagonal output optical window 105. The diffractive layer, or transmission grating 2, is not displayed in this perspective.

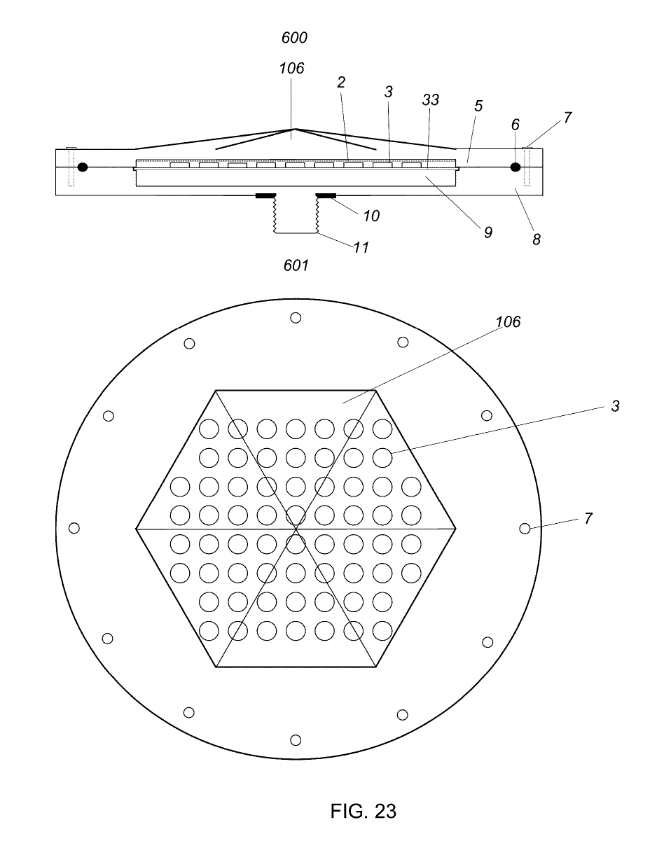

FIG. 23 shows a side perspective 600 of a complete remotely controlled light system comprising upper section 5, which includes a prismatic output window within an overall hexagonal configuration 106. Section 5 also includes a space for the transmission diffraction layer 2, and LED 3 array mounted on a printed circuit 33. The lower section 8 includes a space 9 for the printed circuit 33, batteries, and electronics. The top and lower sections are secured by a series of screws 7 and joined by a circular O ring 6. The lower section includes a central threaded cylinder 10 and rubber, or neoprene, gasket 11 for secured attachment to the pool's wall. FIG. 23 also depicts the corresponding top, or frontal perspective of the hexagonal array of N circular LEDs 3 with a plurality of prisms comprising the hexagonal output optical window 106. The diffractive layer, or grating 2, is not displayed in this perspective.

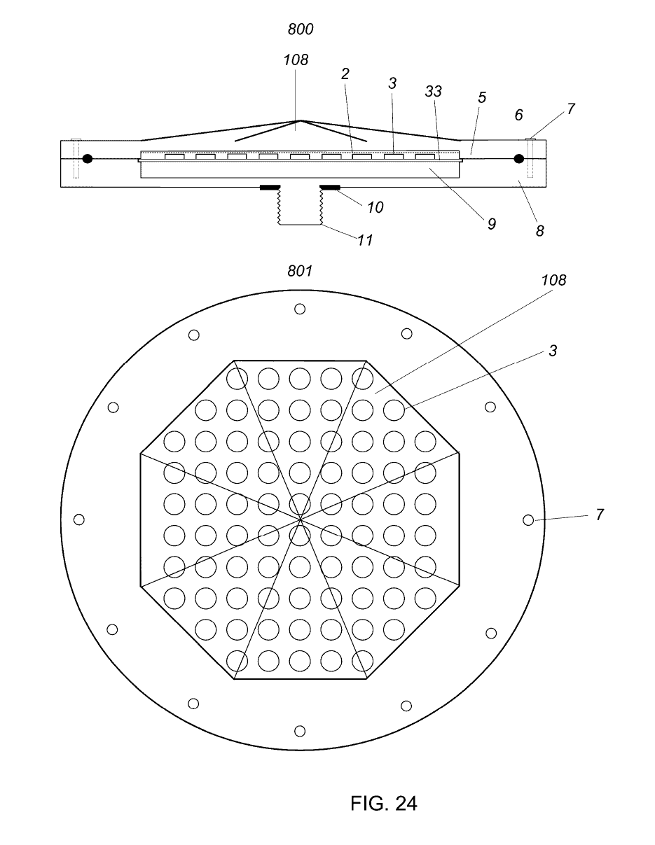

FIG. 24 shows a side perspective 800 of a complete remotely controlled light system comprising upper section 5, which includes a prismatic output window within an overall octagonal configuration 108. Section 5 also includes a space for the transmission diffraction layer 2 and LED 3 array mounted on a printed circuit 33. The lower section 8 includes a space 9 for the printed circuit 33, batteries, and electronics. The top and lower sections are secured by a series of screws 7 and joined by a circular O ring 6. The lower section includes a central threaded cylinder 10 and rubber, or neoprene, gasket 11 for secured attachment to the pool's wall. FIG. 24 also depicts the corresponding top, or frontal perspective of the octagonal array of N circular LEDs 3 with a plurality of prisms comprising the octagonal output optical window 108. The diffractive layer, or grating 2, is not displayed in this perspective.

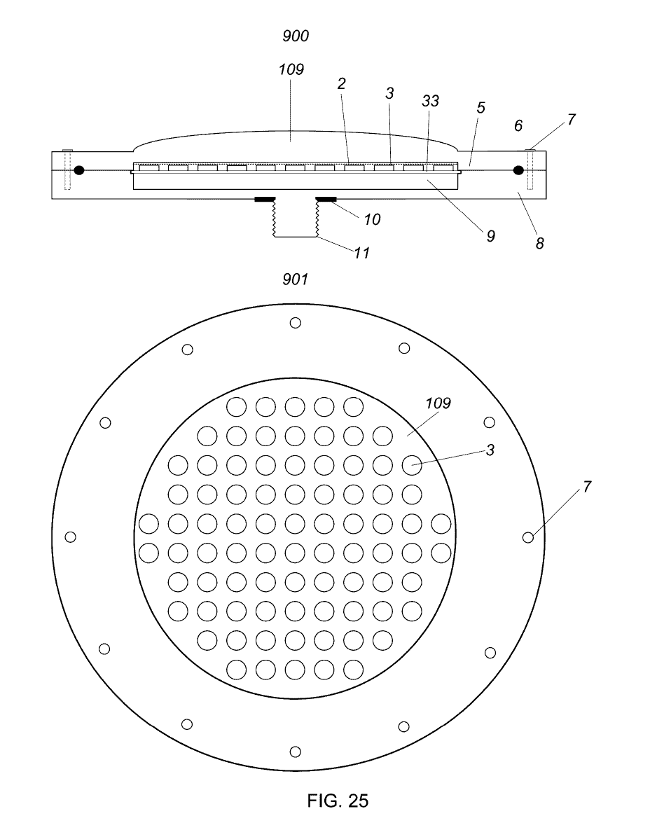

FIG. 25 shows a side perspective 900 of a complete remotely controlled light system comprising upper section 5, which includes a lens output window with an overall circular configuration 109. Section 5 also includes a space for the transmission diffraction layer 2 and LED 3 array mounted on a printed circuit 33. The lower section 8 includes a space 9 for the printed circuit 33, batteries, and electronics. The top and lower sections are secured by a series of screws 7 and joined by a circular O ring 6. The lower section includes a central threaded cylinder 10 and rubber, or neoprene, gasket 11 for secured attachment to the pool's wall. FIG. 25 also depicts the corresponding top, or frontal perspective 901 of the near circular array of N circular LEDs 3 with a circular lens output optical window 109. The diffractive layer, or grating 2, is not displayed in this perspective.

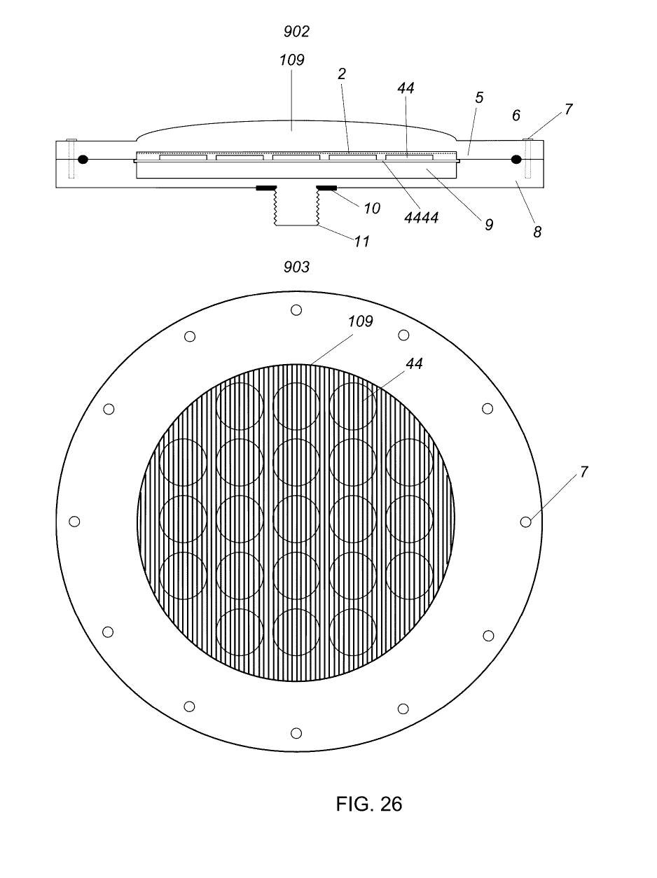

FIG. 26 shows a side perspective 902 of a complete remotely controlled light system comprising upper section 5, which includes a lens output window with an overall circular configuration 109. Section 5 also includes a space for the transmission diffraction layer 2 and an array comprised of larger circular OLEDs 44 mounted on a printed circuit 4444. The lower section 8 includes a space 9 for the printed circuit 4444, batteries, and electronics. The top and lower sections are secured by a series of screws 7 and joined by a circular O ring 6. The lower section includes a central threaded cylinder 10 and rubber, or neoprene, gasket 11 for secured attachment to the pool's wall. FIG. 26 also depicts top, or frontal perspective 903 of the near circular array of N larger area circular OLEDs 44 with a lens output optical window 109.

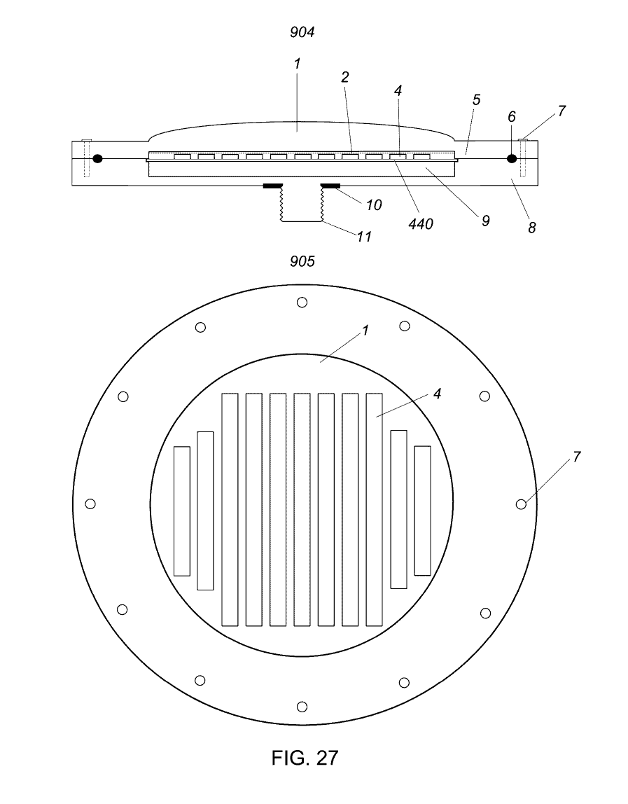

FIG. 27 shows a side perspective 904 of a complete remotely controlled light system comprising upper section 5, which includes a lens output window with an overall circular configuration 1. Section 5 also includes a space for the transmission diffraction layer 2 and an array of N rectangular OLEDs 4 mounted on a printed circuit 440. The lower section 8 includes a space 9 for the printed circuit 440, batteries, and electronics. The top and lower sections are secured by a series of screws 7 and joined by a circular O ring 6. The lower section includes a central threaded cylinder 11 and rubber, or neoprene, gasket 10 for secured attachment to the pool's wall. FIG. 27 also depicts top, or frontal perspective 905 of the near circular array of N larger rectangular OLEDs 4 with a lens output optical window 1. The diffractive layer, or grating 2, is not displayed in this perspective.

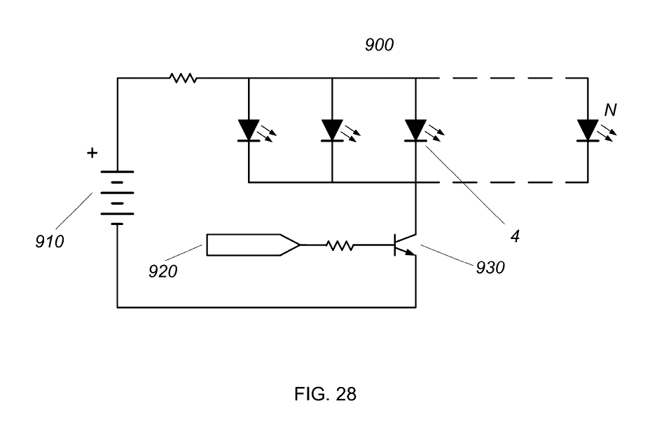

FIG. 28 shows a circuit configuration 900 which is included within the space 9 of the remotely controlled light system. The circuit includes the power source, or battery array 910, remotely control digital circuitry 920, transistor switch 930, and N-element semiconductor illumination array. The N-element semiconductor illumination array is integrated by either N OLEDs 4, N LEDs 3, or a single large OLED 45. The battery power array 910 is comprised, for example, of a series of lithium batteries configured to provide voltages in a suitable practical range, for example in the 5-15 V, range.

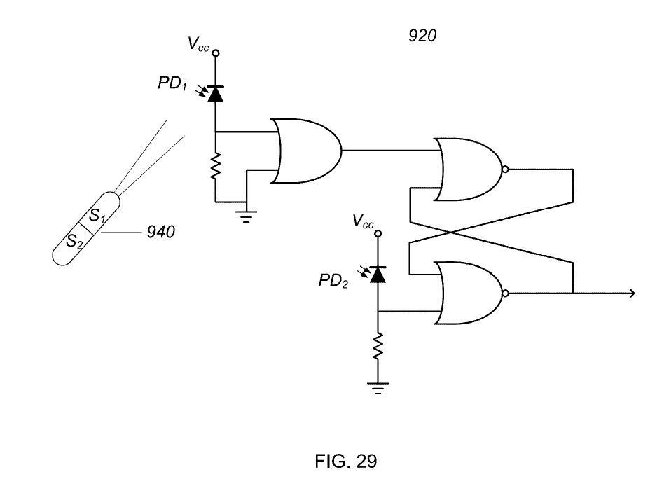

The remotely controlled switch 920 is a low-power consumption digital circuitry activated by an external signal. In the example depicted in FIG. 29 a dual frequency light emitter 940 turns the system ON by illuminating photodiode PD₁ using light source S₁. Following illumination the latch logic circuits stays ON until light source S₂ is used to reset the logic state by illuminating photodiode PD₂. The illumination sources can be low power lasers: a green laser for S₁ and a longer wavelength laser (either yellow or visible red) for S₂. The two photodetectors, PD₁ and PD₂, are installed side-by-side at the upper section of 9 under the optical window. The two emission wavelengths are selected for optimal transmission in water that offers a transmission window centered around 500 nm. The photodiodes can either be narrow-band photodiodes, as described in Q. Lin et al., Filterless narrow-band visible photodetectors, Nature Photonics, 2015, vol. 9, pp. 687-694, for example, or they can incorporate standard narrow-band filters. The bias voltage to the photodiodes V_{cc} is selected to provide a suitable threshold. Additional remote control methods include standard infrared digital remote control circuitry as used in TV systems and as described, in principle, in U.S. Pat. No. 3,631,398. Additional remote controlled switching alternatives includes the use of miniature AM radio transmitter, AM radio receiver, analog-to-digital converters, and logical latch circuitry to activate the switch transistor 930. Yet another alternative includes the use of Bluetooth protocol which allows control from a mobile telephone although this technology requires installation of a light configuration, such as described in FIG. 19, near the water surface with the circuitry at the top of space 9. Not shown in the circuitry 900 is a small pulsed forming circuit, based for example on an LMC555 CMOS integrated circuit, to enable operation in the pulsed domain (at a frequency of about 100 Hz, for example) to save power consumption and reduce heat dissipation.

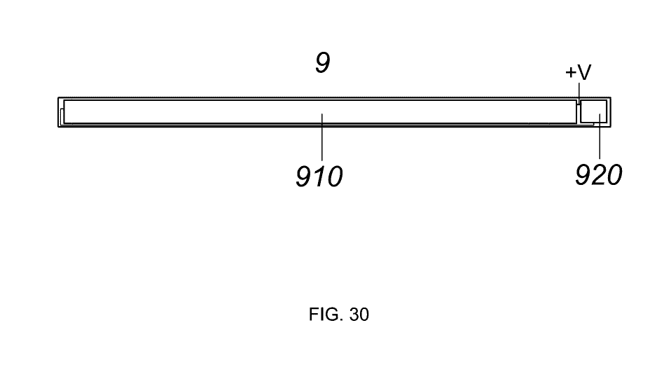

In FIG. 30 the space 9 is shown occupied by the battery array 910 and the electronics 920.

Of course, other perspectives are contemplated, but not shown, such as the complete side perspectives of the rectangular configurations described in FIGS. 1, 2, 3, 4, 5, 6, 7, and 8. Also not shown, within space 9, are details of electrical connections to the printed circuits 33, 440, 444, and 4444.

The output lenses 1, 102, 104, 109, 110 are typically made from a clear plastic, polypropylene, or other similar polymeric material which is lightweight and suitable for use in pool lamp applications. Output prism arrangements 101, 105, 106, 108, 114 are typically made from a clear plastic, polypropylene, or other similar polymeric material which is lightweight and suitable for use in pool lamp applications. An alternative material for output lenses 1, 102, 104, 109, 110 and output prism configurations 101, 105, 106, 108, 114 is glass. The lower structure of these illumination devices 8, 88, and 888, are fabricated of hardened plastic materials similar to that commonly used in poll water return fittings.

In FIGS. 1, 2, 5, 6, 9, 10, 11, 12, 15, 18, 19, 20, 21, 22, 23, 24 and 25 the LED illumination sources can also be replaced by small OLED illumination sources. The LED illumination sources are preferably broadband LED sources, or white light LED sources, as described for example, in U.S. Pat. No. 6,936,857 B2. The OLED illumination sources are preferably broadband OLED sources, or white light OLED sources, as described for example, in L. Ding et al., Orthogonal molecular structure for better host material in blue phosphorescence and large OLED white lighting panel, Advanced Functional Materials, Jan. 28, 2015, vol. 25, No. 4, pp. 645-650. In FIGS. 3, 4, 7, 8, 13, 14, 16, 17, 26 and 27 larger emission area OLED illumination sources are depicted, as described, for example in U.S. Pat. No. 8,692,457 B2 or Y. Tomita et al., Large area p-i-n type OLEDs for Lighting, SID Symposium Digest of Technical Papers, 2007, vol. 38, pp. 1030-1033 and L. Ding et al., Orthogonal molecular structure for better host material in blue phosphorescence and large OLED white lighting panel, Advanced Functional Materials, Jan. 28, 2015, vol. 25, No. 4, pp. 645-650.

In FIGS. 17 and 19, and in perspectives 100, 300, 400, 402, 405, 407, 500, 600, 800, 900, 902, 904 a transmission diffraction grating 2 is included and explicitly displayed. This diffraction grating introduces an interferometric pattern on the transmitted light, as described in more detail in U.S. Pat. No. 5,255,069, F. J. Duarte, Quantum Optics for Engineers (CRC, New York, 2015) and F. J. Duarte, Tunable Laser Optics (CRC, New York, 2015). In these references it is explained that the two-dimensional interferometric equation

$${\vert 〈 x \vert s 〉 \vert}^{2} = {\sum }_{z = 1}^{N} {\sum }_{y = 1}^{N} Ψ ( {r}_{{j}_{zy}} ) {\sum }_{q = 1}^{N} {\sum }_{p = 1}^{N} Ψ ( {r}_{{j}_{qp}} ) {e}^{i ( {Ω}_{qp} - {Ω}_{zy} )} .$$

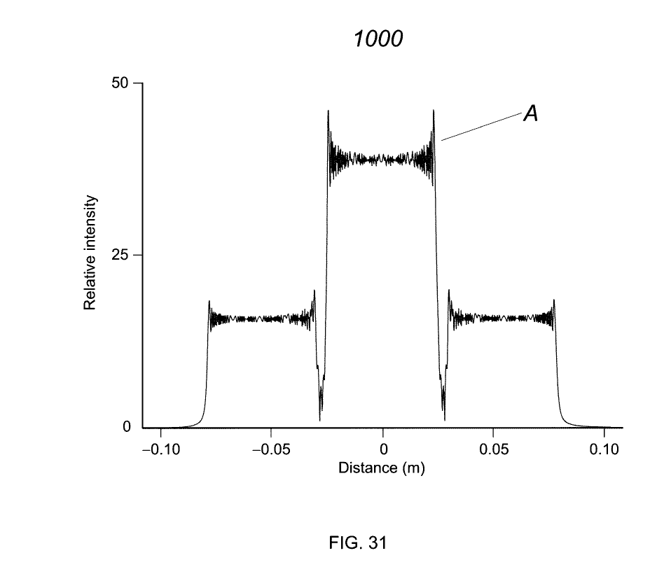

reduces in one dimension to

$${\vert 〈 x \vert s 〉 \vert}^{2} = {\sum }_{j = 1}^{N} {Ψ ( {r}_{j} )}^{2} + 2 {\sum }_{j = 1}^{N} Ψ ( {r}_{j} ) ( {\sum }_{j = m + 1}^{N} Ψ ( {r}_{m} ) cos ( {Ω}_{m} - {Ω}_{j} ) )$$

wherein N is the number of transmission slits, Ψ(rⱼ) represent the amplitudes of “wave functions of ordinary wave optics” as taught in the book by by P. A. M. Dirac, The principles of Quantum Mechanics (Oxford University Press, Oxford, 1978). Here, cos(Ωₘ-Ωⱼ) is the interference term that incorporates information about the emission wavelength λ and the geometry of the interferometric configuration that includes de distance from the diffraction grating 2 to the viewing plane. As taught in F. J. Duarte, Quantum Optics for Engineers (CRC, New York, 2015) and F. J. Duarte, Tunable Laser Optics (CRC, New York, 2015), the transmission diffraction grating produces different illumination patterns according to the dimensions and spacing of the slits comprising the diffraction grating. Thus, different illumination patterns can be produced with different diffraction gratings. For the OLED light configuration depicted in FIG. 17, the cross section of the resulting illumination pattern as described by the interferometric equation is depicted in FIG. 31 in waveform A. In this figure the vertical axis is relative intensity and the horizontal axis represents the spatial width of the emission in metric units. For this particular case the central illumination wavelength is λ=540 nm, the number of slits is N=1250, the width of the slits is 20 □m, separated by 20 □m, the overall width of the grating is 50 mm, and the distance from the grating to the viewing plane is x=4 m. This intensity cross section indicates that the illumination profile A is very bright at the center, surrounded by a dark narrow region, which is itself surrounded by a wider bright region only about half as bright as the central region. Intensity ripples are observed at the central intensity maximum and the secondary intensity maxima. This pattern is itself surrounded by an outer un-illuminated region. Different selection of grating parameters vary the illuminating pattern which also varies as the distance of observation x, from the OLED light, is varied. The experimental validity of the interferometric equation has been amply verified in the refereed journal literature as disclosed in F. J. Duarte, “On a generalized interference equation and interferometric measurements”, Optics Communications, Nov. 1, 1993, vol. 103, Nos. 1-2, pp. 8-14, and F. J. Duarte, L. S. Liao, and K. M. Vaeth, “Coherence characteristics of electrically excited tandem organic light-emitting diodes”, Optics Letters, Nov. 15, 2005, vol. 30, No 22, pp. 3072-3074. The theory described here also applies to broadband, or semicoherent, illumination via multiple computations performed using the interferometric equation as taught in F. J. Duarte, Quantum Optics for Engineers (CRC, New York, 2015).

In FIGS. 2, 4, 6, 9, 10, 11, 19, 20, 21, 22, 23, and 24 the exit optical window is comprised of prismatic configurations. In FIGS. 2 and 4, the transmitted light is refracted by two back-to-back right angled prisms 101. In FIG. 19 the output optical window is configured by a single prism. In FIGS. 20 and 21 the output optical window is comprised of four prisms arranged in a pyramidal configuration 114. In FIGS. 9 and 22 the output optical window is comprised by a plurality of prisms arranged in a pentagonal configuration 105. In FIGS. 10 and 23 the output optical window is comprised by a plurality of prisms arranged in an hexagonal configuration 106. In FIGS. 11 and 24 the output optical window is comprised by a plurality of prisms arranged in an octagonal configuration 108.

The function of the prisms and prismatic configurations described in output windows 101, 105, 106, 114, and 114 is to disperse the broadband spectrum, provided by the broadband OLEDs and LEDs, into individual colors according to the laws of generalized refraction. The generalized multiple-prism dispersion equation is given by F. J. Duarte and J. A. Piper, Dispersion theory of multiple-prism beam expander for pulsed dye lasers, Opt. Commun. 43, 303-307 (1982) and F. J. Duarte, Tunable Laser Optics (CRC, New York, 2015). For a single prism the generalized multiple-prism dispersion equation reduces to

$$\frac{\partial {φ}_{2 , 1}}{\partial λ} = ( \frac{sin {ψ}_{2 , 1}}{cos {φ}_{2 , 1}} ) \frac{\partial n}{\partial λ} + ( \frac{cos {ψ}_{2 , 1}}{cos {φ}_{2 , 1}} ) ( \frac{sin {ψ}_{1 , 1}}{cos {ψ}_{1 , 1}} ) \frac{\partial n}{\partial λ}$$

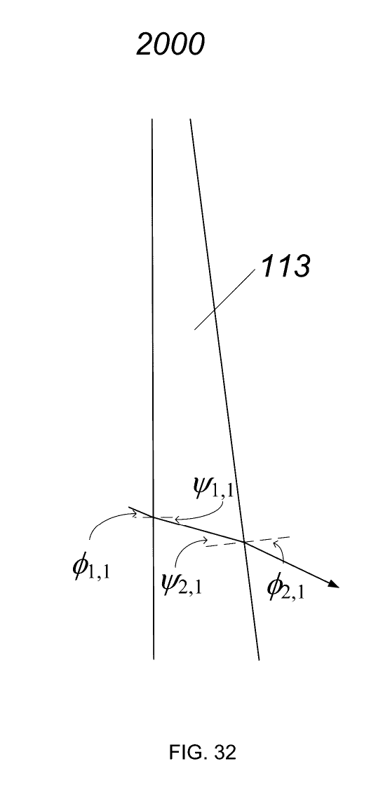

as given by M. Born and E. Wolf, The Principles of Optics (Cambridge University, Cambridge, 1999) and F. J. Duarte, Tunable Laser Optics (CRC, New York, 2015). In this equation φ_{1,1} is the angle of incidence at the first surface and ψ_{1,1} is the corresponding angle of refraction. Likewise, φ_{2,1} is the angle of emergence at the exist surface and ψ_{2,1} is the corresponding angle of refraction, as illustrated in FIG. 32. The spread of φ_{2,1} as a function of wavelength is the dispersion. For the light ray including designated angles in 2000 shorter wavelengths will be deviated at larger angles of emergence while longer wavelengths will be deviated at smaller angles of emergence. Thus, pyramidal 114, pentagonal 105, hexagonal 106, octagonal 108, and additional polygonal prismatic optical windows produce intricate and complex dispersion patterns or intricate and complex rainbow patterns of light.

Furthermore, in reference to non-prismatic configurations as illustrated in FIG. 1, 5, 7 8, 12, 13, 14, 15, 16, 17, 18, and FIGS. 25-27, it should be realized by one with ordinary skill in the art that emission at various different colors can be accomplished simply using OLEDs and LEDs emitting a different peak wavelengths. For example, in reference to FIG. 25, the first 4 rows of LEDs can be red emitting LEDs, the second 3 rows of LEDs can be green emitting LEDs, and the third 3 rows of LEDs can be blue emitting LEDs. Alternative to horizontal divisions of colors a similar scheme of RGB emission can be accomplished by dividing the LED arrangement into columns emitting in the red, green, and blue.

It is understood that the diffractive optics, prismatic optics, illumination configurations, electronic circuits, and materials, described herein are illustrative of the general principle of the invention and modifications may be readily devised by those skilled in the art without departing from the spirit and scope of the invention. For instance, the transmission diffraction gratings can be one dimensional or two-dimensional. Also, the various N OLED arrays, and LED arrays, described herein can be matched to either planar, lens, or prismatic optical windows. Although reference is made herein to optical windows made of glass and optical grade acrylic plastic, other suitable transparent polymers are also applicable. Additionally, the O rings and gaskets can be made of rubber, neoprene, or other appropriate polymeric material. Furthermore, it is understood that polygonal configurations with more than 8 sides are also part of the spirit and scope of the invention.

All documents, patent applications, patents, journal articles, references, and other materials cited in the present application are hereby incorporated by reference. It will be appreciated from the foregoing that the present invention represents a significant advance in the field of underwater pool lights. In particular, the invention provides for a relatively light weight, cable less, remotely controlled, wireless, battery powered, non-metal housing, solid-state semiconductor (OLED and/or LED), underwater diffractive and prismatic light source. It will also be appreciated that, although specific embodiments of the invention have been described in detail for purposes of illustration, various modifications may be made without departing from the spirit and scope of the invention.

The presently disclosed embodiments are therefore considered in all respects to be illustrative and not restrictive. The scope of the invention is indicated by the appended claims, and all changes that come within the meaning and range of equivalents thereof are intended to be embraced therein.

The invention claimed is:

1. A remotely controlled, wireless, battery powered, waterproof, solid-state semiconductor light-emitting device, comprising:
an array of N OLEDs, covered by a transmission diffraction grating, and a prismatic output optical window.

2. The light-emitting device of claim 1 wherein the array of N OLEDs is linear.

3. The light-emitting device of claim 1 wherein the array of N OLEDs forms a polygonal geometry.

4. The light-emitting device of claim 1 wherein the array of N OLEDs forms a circular geometry.

5. The light-emitting device of claim 1 wherein the illumination is provided by a single (N=1) large area OLED.

6. A remotely controlled, wireless, battery powered, waterproof, solid-state semiconductor light-emitting device, comprising:
an array of N OLEDs, covered by a transmission diffraction grating, and a lens output optical window.

7. The light-emitting device of claim 6 wherein the array of N OLEDs is linear.

8. The light-emitting device of claim 6 wherein the array of N OLEDs forms a polygonal geometry.

9. The light-emitting device of claim 6 wherein the array of N OLEDs, or N LEDs, forms a circular geometry.

10. The light-emitting device of claim 6 wherein the illumination is provided by a single (N=1) large area OLED.

11. The light-emitting device of claim 6 wherein the diffraction grating is configured to project a particular image or character.

12. A remotely controlled, wireless, battery powered, waterproof, solid-state semiconductor light-emitting device, comprising:
an array of N LEDs, covered by a transmission diffraction grating, and a prismatic output optical window.

13. The light-emitting device of claim 12 wherein the array of N LEDs, is linear.

14. The light-emitting device of claim 12 wherein the array of N LEDs forms a polygonal geometry.

15. The light-emitting device of claim 12 wherein the array of N LEDs forms a circular geometry.

16. A remotely controlled, wireless, battery powered, waterproof, solid-state semiconductor light-emitting device, comprising:
an array of N LEDs, covered by a transmission diffraction grating, and a lens output optical window.

17. The light-emitting device of claim 16 wherein the array of N LEDs, is linear.

18. The light-emitting device of claim 16 wherein the array of N LEDs forms a polygonal geometry.

19. The light-emitting device of claim 16 wherein the array of N LEDs forms a circular geometry.

20. The light-emitting device of claim 16 wherein the diffraction grating is configured to project a particular image or character.
